(19) United States
(12) Patent Application Publication
(10) Pub. No.: US 2003/0055967 A1
(43) Pub. Date: Mar. 20, 2003

(54) ENCAPSULATING LOCAL APPLICATION ENVIRONMENTS IN A CLUSTER WITHIN A COMPUTER NETWORK

(76) Inventor: DAVID DEWITT WORLEY, LEXINGTON, SC (US)

Correspondence Address: Craig N. Killen, Nelson Mullins Riley & Scarborough, P.O. Box 11070, Columbia, SC, 29211-1070, US

(21) Appl. No.: 09/313,495

(22) Filed: May 17, 1999

(51) Int. Cl. G06F 15/16; G06F 15/173

(52) U.S. Cl. 709/226; 709/206; 714/10

(57) ABSTRACT

A back-up system for a computer program running within a network of servers. Multiple instances of the program are installed and configured, each on a different server. The configuration generates an “environment” for each instance, which is an entity required for the instance to run. One (or more) instances are selected as the active instances, and they run; the others remain dormant. The environments of the active instances are backed up to storage which is shared by all servers. If an active instance fails, its environment is copied from the storage to a dormant instance, which then becomes active. This transition process is vastly faster than one alternative, namely, installing another instance from scratch.

In a system of computers, one instance of a computer program runs, and is called the “active” instance. Other instances exist, but are dormant, and act as back-ups. If the active instance fails, the environment of the active instance is transferred to a dormant instance, and the dormant instance becomes the active instance. This transition is much faster than maintaining no dormant instances, and then fully installing a replacement instance when the active instance fails.

### BACKGROUND OF THE INVENTION

Electronic mail systems are in widespread use for delivering e-mail messages. The individual parties who send, and receive, e-mail messages do so by dealing with an electronic mail handler. The e-mail handler is a sophisticated set of one, or more, computer programs which run on a server. Each individual party deals with the server through the party's own computer, which is called a “client.”

If a malfunction occurs in the server running the e-mail handler, the clients can be deprived of e-mail service until the malfunction is corrected. Because this deprivation creates significant problems, measures are taken to prevent it.

One measure used in the prior art is illustrated in FIG. 1. Two servers S contain identical e-mail handlers H1 and H2. Associated with each handler is a Registry R1 and R2, which contain data required by the handlers. Registries are explained more fully below, in the Detailed Description of the Invention. Both Registries R1 and R2 are identical, at least initially.

One of the handlers, such as H1, runs, and handles the e-mail. The other handler H2 acts as a back-up. If a malfunction occurs, the back-up handler H2 takes over, while handler H1 is repaired.

However, this take-over is not necessarily accomplished in a simple manner. One reason is that the Registry R1 of the initial handler H1 may have changed. The changes in Registry R1 must be carried over to registry R2, if handler H2 is to act as a complete replacement of handler H1.

This replacement ordinarily entails a comparison of the two Registries, with accompanying additions and deletions made to Registry R2, to create a duplicate of Registry R1. This process is time-consuming, and can be made difficult if the malfunction blocks access to Registry R1.

### OBJECTS OF THE INVENTION

An object of the invention is to provide an improved computer system.

A further object of the invention is to provide an improved back-up system for computer processes running on a network.

### SUMMARY OF THE INVENTION

In one form of the invention, multiple instances of a program are installed within multiple servers. The installation processes generate an entity for each instance, which is called an “environment.” In general, all environments are different from each other.

Only one installed instance actually runs, namely, the “active” instance. Its environment is backed up to storage which is shared by all servers. The other instances remain dormant, and act as back-ups. However, because the dormant instances have been equipped with environments, they are nevertheless capable of running and providing services. But their services are not precisely identical to those of the active instance. One reason is that the environments utilized by the dormant instances differs from that used by the active instance.

If the active instance fails, its environment is transferred to a dormant instance, and the latter instance takes over, providing the identical services to those of the previously active instance.

### BRIEF DESCRIPTION OF THE DRAWINGS

FIG. 1 illustrates a prior art system.

FIGS. 2-4 illustrate various aspects of different embodiments of the invention.

FIG. 2A illustrates a system of servers, in order to define the concept of links-to-files.

FIG. 5 is a flow chart illustrating logic implemented by one form of the invention.

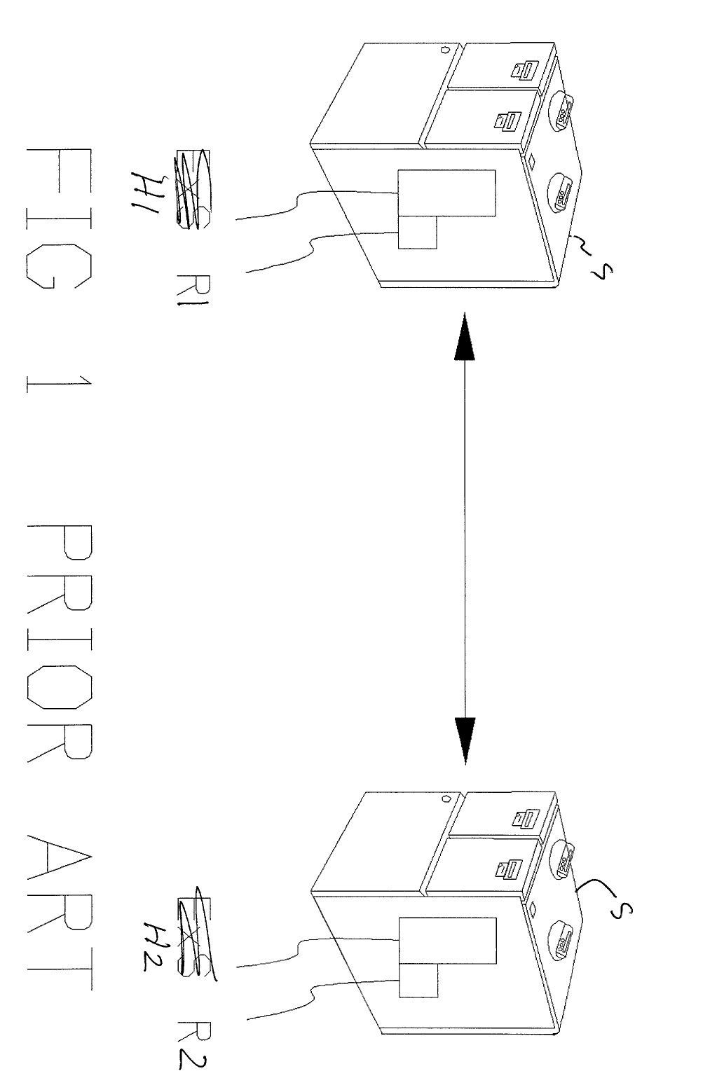

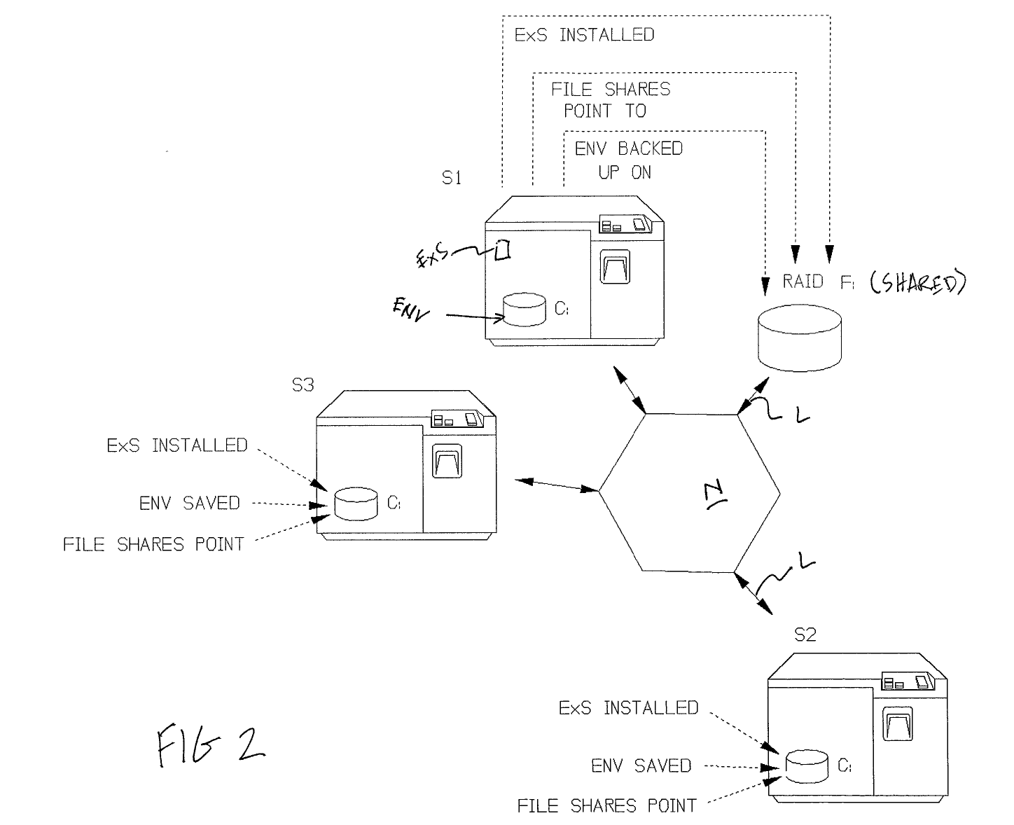

### DETAILED DESCRIPTION OF THE INVENTION

### The System

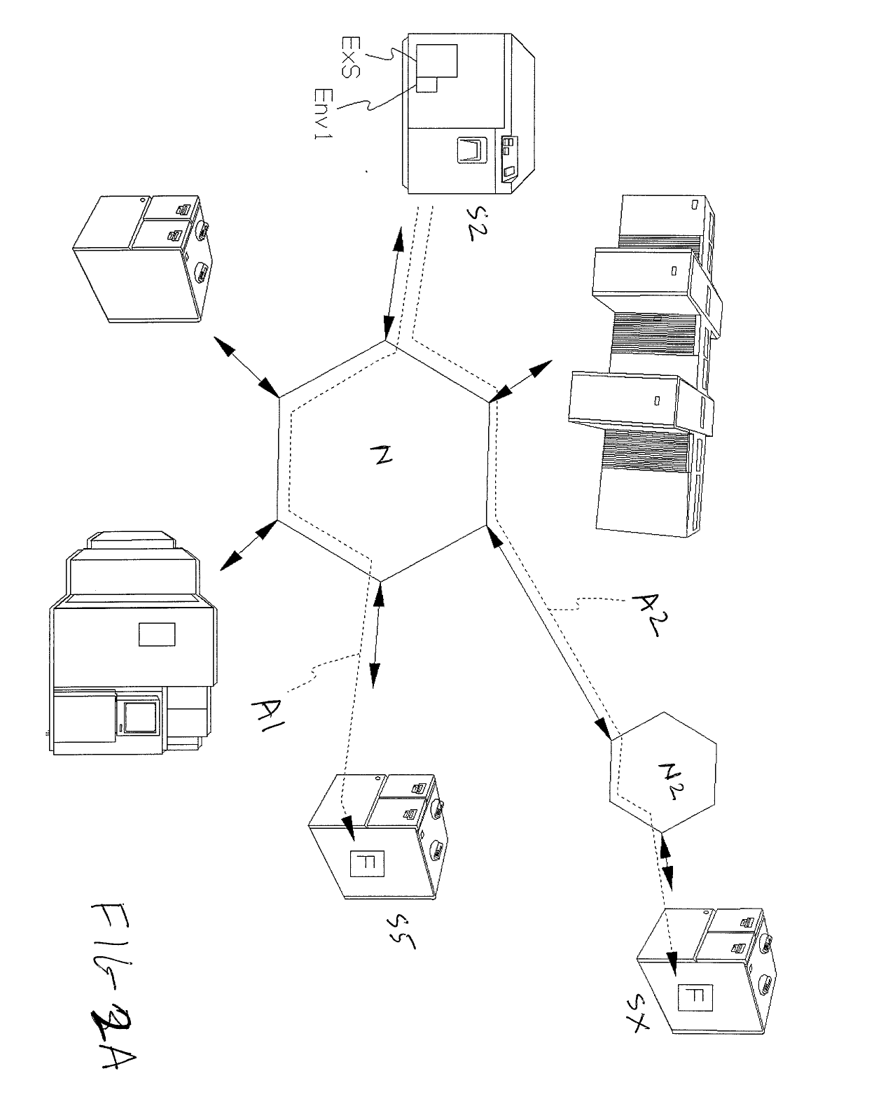

FIG. 2 illustrates three servers S1-S3, connected into a network N by communication links L. An electronic mail handling service, such as the package Exchange Server, available from Microsoft Corporation, Redmond, Wash., runs on one of the servers, such as server S1, as indicated by the label ExS.

While the present discussion is framed in terms of the package Exchange Server, it should be understood that the invention is applicable to computer processes generally.

### “Environment”

The package ExS requires an “environment,” which contains three primary components, (1) a Registry, (2) links to files, and (3) file-share data, each of which will now be explained.

1. The Registry. The operating system Windows NT, available from Microsoft Corporation, utilizes a component termed a “Registry” in its operation. A simple example will illustrate the functioning of the Registry.

Assume a system in which multiple computers are connected together in a network. Assume that a single printer provides printing services to the users of the computers. When a user wishes to print a document, the user sends the document to a print-services program which operates the printer. The print-services program handles printing of the document.

However, the print services program requires certain information. It must know items such as (1) where the printer is located, (2) the type of printer, (3) which users are allowed to use the printer, (4) whether a page limit is imposed on users and, if so, (i) which users are subject to the limit and (ii) the limit itself, and so on.

This information is commonly called “configuration” information, and is stored in the Registry.

As another example, the operating system may run a local electronic mail (e-mail) system. However, e-mail systems generally are not identical, and each has its own individual characteristics. Specifically, each e-mail system will package its e-mail messages differently, using different headers and other file conventions.

The system administrator may add a service, or program, which allows the local e-mail system to communicate with other e-mail systems. The service translates the messages used in the local e-mail system into the formats utilized by other e-mail systems, thereby allowing local users to communicate with users of other systems.

The Registry contains information necessary for implementing the translation service.

Therefore, the Registry contains specific information which is necessary for operation of individual programs within the system. Further details considering the nature of the Registry are contained within the documentation provided by Microsoft concerning the operation of the NT system, as well as in documentation provided by third-parties. These details are considered part of the prior art, and well known.

2. Links to files. Assume that server S2 in FIG. 2A runs a process, or program ExS. That process may require files, which may contain data, or other programs. Those files may be located at one, or more, remote locations. Thus, server S2 must be able to gain access to those files, indicated by blocks F in FIG. 2A. The access is indicated by the dashed arrows A1 and A2.

The Inventor points out that the general case is indicated in the Figure: arrow A1 points to a server connected to the same network as the server requiring the file, namely, server S2. However, arrow A2 points to a server SX connected to a different network N2.

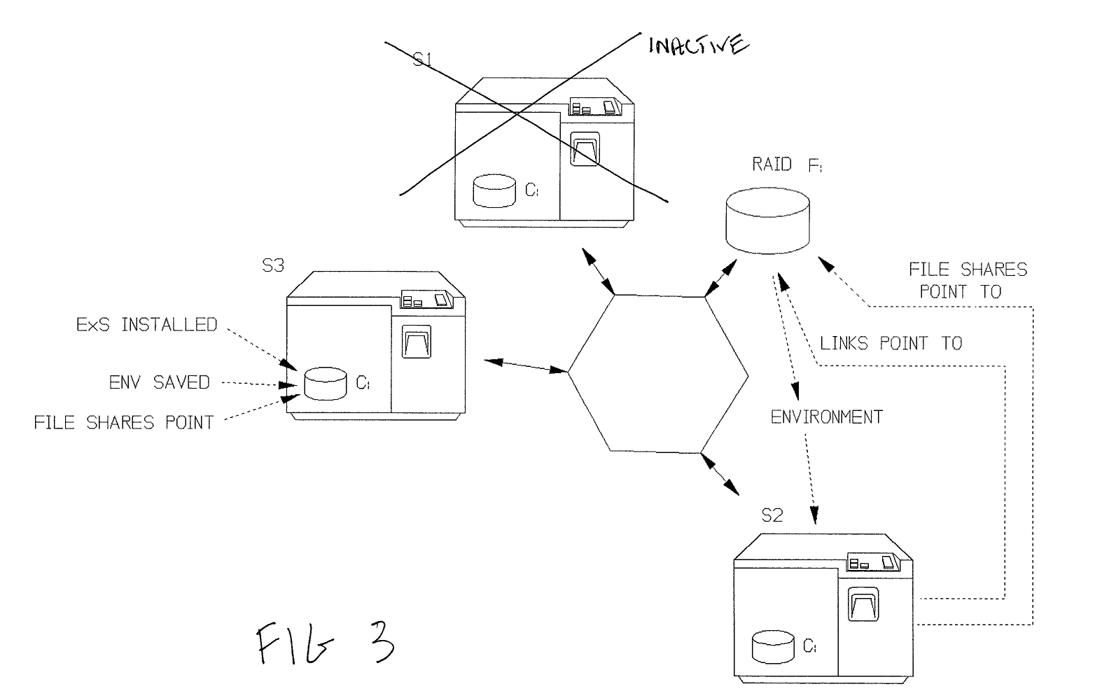

The information which identifies the location of a required file F is called a “link.” If (1) the process in question, running on server S2 in FIG. 3, is the Exchange Server, and (2) if the operating system is the NT system identified above, which is almost a certainty, then the links will ordinarily be stored in a file located in the following directory location within server S2:

%SystemRoot%\Profiles\All users\Start Menu\Programs\Microsoft Exchange.

A primary use for the files F is in system administration. The files F contain programs and data which are used by the system administrator.

3. File-share data. As stated above, each individual user operates a computer, termed a “client,” which connects to a server. The clients are not shown in the Figures. Each client generally contains a mass storage device, such as a fixed disc drive.

In addition, each client is given access to other disc drives, some of which may be contained within the client's server, and some of which may be contained within other servers. Under the file-share concept, set-up processes are run which assign a simple name to the disc drives which are made available to, or “shared” with, each client.

That is, these processes label each shared drive with alphabetical labels. After set-up, the person operating a client addresses the drives by letters such as “c:”, “d:”, “e”, and so on. Some of the drives may be contained within the user's local computer, and others may be located elsewhere. However, under the sharing procedure, the user is not required to know the locations of the shared devices. That is, the user is not concerned with the fact that drive “e:” may be located in server S5, and is not required to specify server S5 when addressing that drive. The share-software handles that task. To the user, the drives appear local, and are addressed as such.

The file-share data contains information required to set up the sharing of the drives.

File-sharing applies not only to clients, but also to the servers.

The file-sharing operation has particular relevance to older systems, such as Microsoft Mail Server, which operate on older operating systems, such as DOS, Disc Operating System. These older systems are termed “legacy” systems. The file-sharing operation allows users of Exchange Server to retrieve e-mail messages stored on the legacy systems.

### Handling of Environment

The environment ENV for server S1 in FIG. 2, which includes the three elements just described, is stored locally within that server, such as within fixed drive c:, as indicated. That environment is also backed up to incorruptible storage, such as to the RAID labeled drive f:. “RAID” is an acronym for Redundant Array of Independent Drives. RAIDs are known in the art.

The RAID has the characteristic of being shared by all servers. That is, all servers can gain access to RAID, to retrieve a copy of the necessary environment.

As indicated by the dashed arrows pointing to the RAID, (1) the program ExS is installed on it, (2) the environment ENV is backed up on it, as just stated, and (3) the file shares, which are part of the environment, point to it.

Both of the two other servers, S2 and S3, contain installations of ExS, but these installations are somewhat different, in at least three respects.

First, in both S2 and S3, the program ExS is installed on a local drive, labeled “c:” In contrast, for server S1, the program ExS is installed into shared storage, such as the RAID.

Second, in both S2 and S3, the environment ENV is stored within the local drive “c:”, as indicated. This storage is different from that of server S1, because in the latter the environment is stored both within local storage c:, and also backed up in the RAID. In addition, all three environments will, in general, be different from each other.

Third, the file shares (which are part of the environment) within S2 and S3 point to their local storage c:. In contrast, the corresponding pointers in server S1 point to the RAID.

### Operation of System

With this arrangement, the program ExS within server S1 runs, and provides service to its clients (not shown). That program is called the active instance of ExS. The installed programs ExS within servers S2 and S3 are dormant, but still capable of running. They are called dormant instances.

If a dormant instance were to run, it would not provide the identical services to its clients as does the active instance, because the environments of the dormant instances are different from that of the active instance. As a simple example, the environment of the active instance lists the names of the persons to whom e-mail services are to be rendered. The environments of the dormant instances will contain different lists, if any lists at all.

### Behavior on Failure

If the active instance fails, or if server S1 fails, the system is modified into the configuration shown in FIG. 3. The active instance is terminated, or suspended, as indicated by the label INACTIVE adjacent server S1. Server S1 no longer runs the program ExS.

The modification, in brief, is this: a replacement server is chosen, such as server S2. This server is then configured so that it acquires the characteristics formerly possessed by server S1, as shown in FIG. 2. This re-configuration of S2 is accomplished primarily by equipping it with the identical environment of server S1.

In more detail, the environment of server S1 is copied to server S2, and replaces the previous environment of server S2. This environment is copied from the RAID, and delivered to the local storage in server S2. With this copying, server S2 acquires the configuration previously existing in server S1: server S1 previously stored its environment in its local storage c:, with a back-up stored in the RAID. Now, server S2 stores that same environment in its local storage c: (as opposed to server S2's own environment), with a back-up stored in the RAID.

Further, the file shares and the links of server S2, which are part of the environment, now point to the RAID, whereas they previously pointed to the local drive c: in server S2.

### Characterization

From one point of view, three instances of the program ExS are installed, and configured, within the three servers S1-S3. One instance is active, and the other two are dormant.

The configuration of each is determined by configuration parameters, and those are contained in the environments. The environment utilized by server S1, which runs the active instance, provides the active, operational configuration parameters. That environment will, in general, change over time.

The other environments, namely, those associated with the dormant instances, are not used for their configuration parameters. Rather, they are used for their structures, so that, later, the configuration parameters themselves can be loaded into a dormant instance.

Thus, in a sense, the environments for the dormant instances are “dummies.” Those environments are not used for the parameters they contain. Rather, they are used as “shells,” which are set up in advance, namely, at the time of their installations. The shells become filled with configuration data when the associated dormant instance is to become an active instance.

Stated in other words, first an active program ExS is installed on a server, together with its environment. In addition, dormant instances of the ExS, each with a respective environment, are installed on other servers.

With these preliminary installations, it is a simple and rapid matter to (1) select a dormant instance and (2) change its environment to that of the active instance. Thus, a dormant instance can be called into action, to replace a failed active instance, in a very short time, in the range of dozens of seconds or a few minutes. Further, the dormant instance will perform identically to the failed instance, because the dormant instance is equipped with the environment of the failed instance.

In contrast, if no dormant instances existed with their associated environments, then, in order to generate a back-up instance to replace a failed active instance, the entire program ExS must be set up and configured. This process consumes a significant amount of time, in the range of one-half hour, for a “bare bones” system.

Further, much of the process of equipping the dormant instance with a new environment involves merely changing pointers, as indicated in FIG. 3. Of the three components of the environment, only the Registry is actually transferred to the server containing the dormant instance; a change of pointers is involved in the other two.

### Additional Embodiment

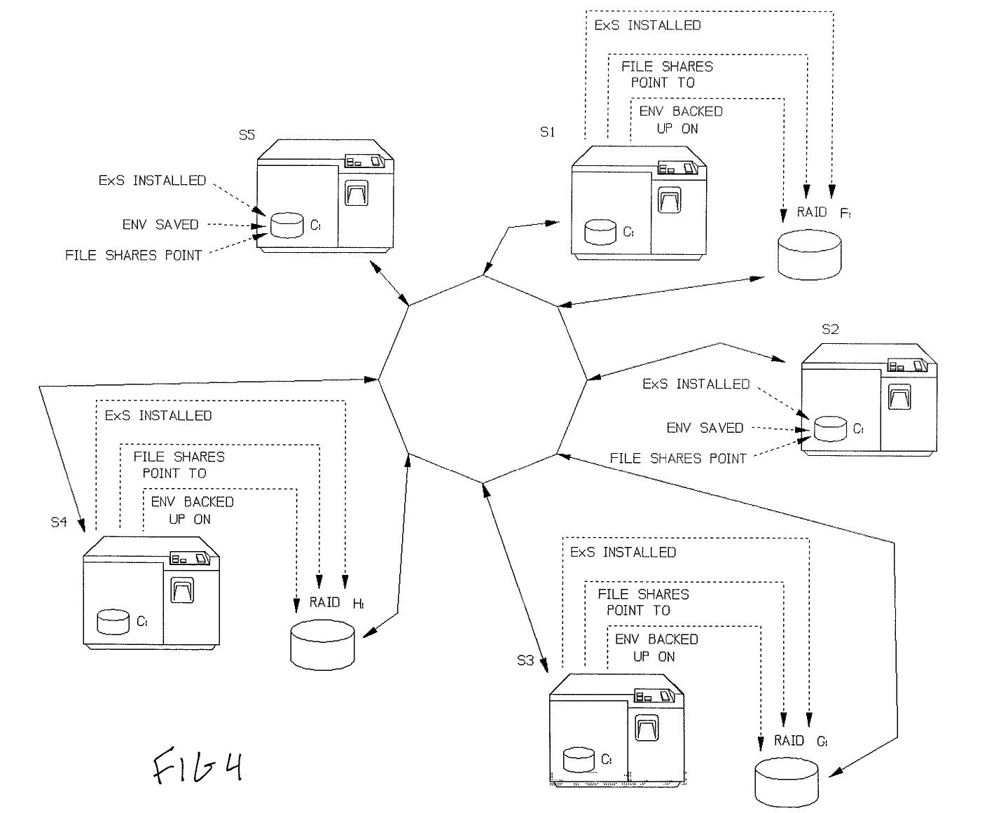

FIG. 4 illustrates a typical system. Five servers are shown. Servers S1, S3, and S4 run active instances, and each is structured like server S1 in FIG. 2. Servers S2 and S5 act as back-up. If any of the active instances fail, a shift to one of the back-ups is undertaken, as described in connection with FIG. 2.

### Flow Chart

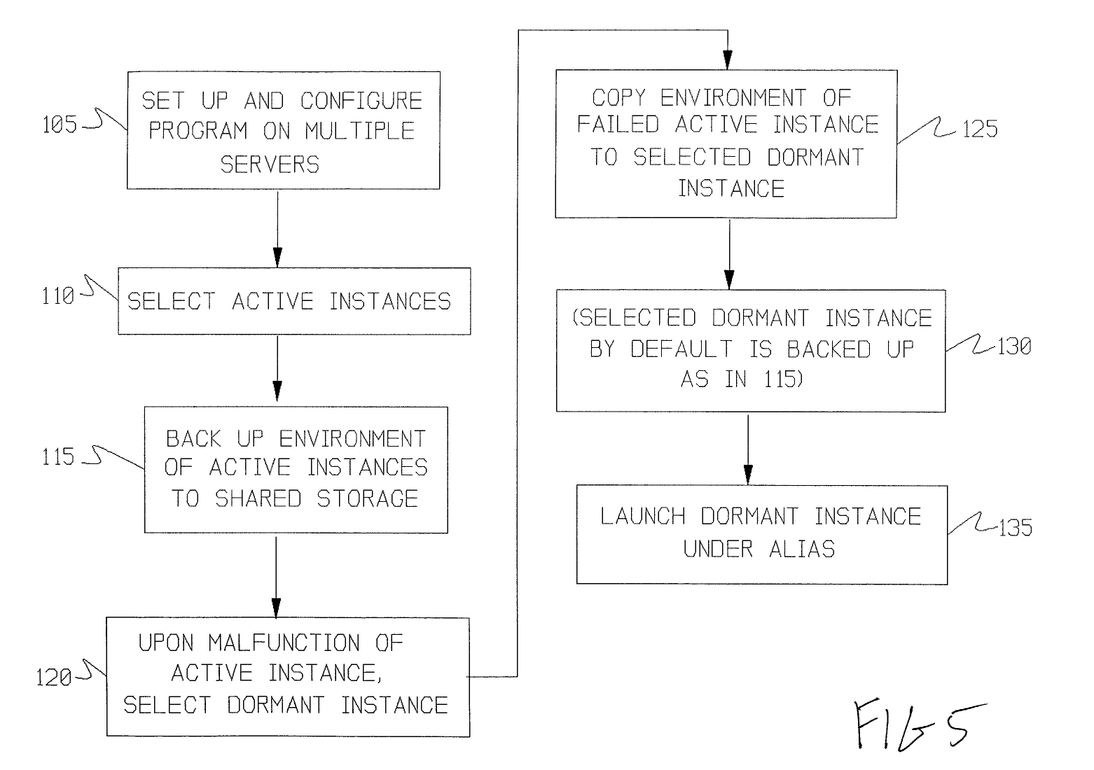

FIG. 5 illustrates logic implemented by one form of the invention. In block 105, the program is set up and configured on multiple servers. In block 110, one, or more, instances of the program are selected as active instances. For each, in block 115, the backing-up to a RAID, or other permanent storage, indicated in FIG. 2 is undertaken. The other instances are dormant.

In block 120, if an active instance does not operate satisfactorily, a dormant instance is selected as a replacement. In block 125, the environment of the previous active instance is transferred to the chosen dormant instance. At this time, the dormant (now active) instance is, in effect, backed up, just as the original active instance was backed up, as indicated by block 130.

Block 135 indicates that the launch of the dormant instance occurs under an alias. Specifically, the variable ActiveComputerName utilized by the operating system is set to an alias, which travels along with the environment from the previously active instance to the dormant instance.

The reason is the following. The mail handler is given a name, which acts as an e-mail address. For example, a given person Smith may have an e-mail address Smith@Server1, indicating that Smith's handler runs on server 1. All incoming mail to Smith must contain this address.

By design, Exchange Server adopts the name of the server on which it runs. Thus, under the example given above, a dormant instance launched on server 5, would assume the name “server 5.” After this launch, Smith will not receive his e-mail: Smith's mail is directed to server 1, but “server 5” is now handling the e-mail.

To accommodate this, the instance of block 125 in FIG. 5 is launched under the alias of “server 1.” That is, the instance of Exchange Server running on server 5 is “tricked” into believing that it runs on server 1.

### Additional Considerations

1. A related patent application by the same inventor, filed concurrently herewith, and entitled “Protection of Registry in Networked Environment” is hereby incorporated by reference.

A copy of this application is attached hereto, and is made part hereof, by physical attachment.

2. When a back-up transition occurs, an instance of the program in question is run on a back-up server. That instance can be retrieved from local storage within that server. Alternately, it can be retrieved from the shared RAID, which contains the installation of the active instance.

Numerous substitutions and modifications can be undertaken without departing from the true spirit and scope of the invention. What is desired to be secured by Letters Patent is the invention as defined in the following claims.

1. Method of operating a system of servers linked together in a network, comprising the following steps:
a) providing services to users by utilizing
(i) an active program which runs on a server, and
(ii) an environment associated with the active program; and
b) maintaining, but not running, a substantially identical program, together with an associated dummy environment, on another server.

2. Method according to claim 1, and further comprising the following steps:
c) replacing the dummy environment with the first environment; and
d) running the identical program.

3. Method according to claim 2, wherein the steps of paragraphs (c) and (d) are taken in response to a malfunction in either (i) the active program or (ii) equipment required to run the active program.

4. Method according to claim 2 and further comprising the following step:
e) terminating operation of the active program.

5. Method of operating a system of servers linked together in a network which comprises a shared file store (RAID), comprising the following steps:
a) maintaining a first installation on a first server, wherein
i) a first instance of a common program is maintained on the shared file store (RAID);
ii) a first environment is maintained in storage within the first server; and
iii) the first environment is backed up on the shared file store (RAID);
b) maintaining a second installation on a second server, wherein
i) a second instance of the common program
A) is maintained in non-shared storage of the server; and
B) does not run; and
ii) a second environment is maintained in storage within the second server, and not in the shared file store (RAID).

6. Method according to claim 5, wherein
i) file share pointers within the first installation point to the shared file storage (RAID) and
ii) file share pointers within the second installation point elsewhere.
